(19) United States
(12) Patent Application Publication
(10) Pub. No.: US 2016/0127498 A1
(43) Pub. Date: May 5, 2016

(54) METHOD AND APPARATUS FOR PROVIDING INFORMATION TO AN APPLICATION IN A MOBILE DEVICE

(71) Applicant: AT&T Mobility II LLC, Atlanta, GA (US)

(72) Inventors: Biren Parekh, Cumming, GA (US); Sheldon Kent Meredith, Marietta, GA (US)

(21) Appl. No.: 14/531,810

(22) Filed: Nov. 3, 2014

(51) Int. Cl. H04L 29/08

(52) U.S. Cl. CPC H04L 67/2852; H04L 67/1097

(57) ABSTRACT

A method, computer readable medium, and an apparatus for providing information to an application of a mobile endpoint device are disclosed. For example, the method receives a request for the information from the application of the mobile endpoint device, and provides the information to the application from a cache when the application is deemed to be a non-critical application.

The present disclosure relates generally to providing information to an application, e.g., to a mobile application, by a mobile device that accesses services from a wireless network, e.g., a long term evolution (LTE) based wireless network, and the like.

### BACKGROUND

When a particular software application implemented in a mobile device requests for information from the mobile device, the operating system of the mobile device is tasked with processing the request. For example, a subscriber may access a mobile application, e.g., a location-based mobile photo-sharing application, to post a picture onto a social networking site. The location-based mobile photo-sharing application may have an innate feature where location information will be associated with any picture that will be posted to the social networking site. As such, the location-based mobile photo-sharing application may send a request for location information to the operating system of the mobile device. Accordingly, the operating system will determine the location of the mobile device in real time and provide the location information to the location-based mobile photo-sharing application. The location-based mobile photo-sharing application may then tag the picture with the appropriate location information when the picture is posted on the website.

Unfortunately, there are many mobile software applications that use the same information. For example, mobile software applications such as Spotify®, Google maps®, etc., may also need location information. In another example, security capabilities of a device may also be used by various mobile software applications.

Each time, the operating system (OS) of the mobile device receives a request from one of any number of mobile software applications that need a commonly used information, e.g., the location information, the operating system determines the location information in real-time, and provides such location information to the particular mobile software application from which the request is received. Unfortunately, the location information may be repeatedly requested by the various mobile software applications within the mobile device, thereby causing multiple requests for the same location information to be serviced by the OS. In turn, such multiple requests cause the operating system to repeatedly determine, in real-time, the same location information. As a result, the processing capacity and battery life of the mobile device may be reduced. In addition, the cause for the degradation of performance of the mobile device is transparent to the user since the user may not be aware of the vast number of mobile software applications that are constantly requesting for the same information from the OS. This degradation in performance may lead the user to harbor a negative sentiment toward the network service provider and/or the manufacturer of the mobile device.

### SUMMARY OF THE DISCLOSURE

In one embodiment, the present disclosure describes a method, computer readable medium, and apparatus for providing information to an application of a mobile endpoint device. For example, the method receives a request for the information from the application of the mobile endpoint device, and provides the information to the application from a cache when the application is deemed to be a non-critical application.

### BRIEF DESCRIPTION OF THE DRAWINGS

The teaching of the present disclosure can be readily understood by considering the following detailed description in conjunction with the accompanying drawings, in which:

FIG. 1 illustrates an example network related to the present disclosure;

FIG. 2 illustrates a method of the present disclosure for providing information to a software application of a mobile device;

FIG. 3 illustrates a method of the present disclosure for providing a billing for a software application of a mobile device; and

FIG. 4 depicts a high-level block diagram of a computer suitable for use in performing the functions described herein.

To facilitate understanding, identical reference numerals have been used, where possible, to designate identical elements that are common to the figures.

### DETAILED DESCRIPTION

The present disclosure broadly describes a method, computer readable medium, and apparatus for providing information to a software application of a mobile device. Although the teachings of the present disclosure are discussed below in the context of a long term evolution (LTE) based wireless network, the teaching is not so limited. Namely, the teachings of the present disclosure can be applied for network services received via any other types of wireless networks (e.g., 2G network, 3G network, and the like), wherein improving a performance of a mobile device, that is accessing services via any type of a wireless network, is beneficial.

In one embodiment, the method of the present disclosure first implements an intermediary layer that operates between software applications implemented in the mobile device and the operating system of the mobile device. The intermediary layer can be utilized for managing access to information by the software applications. In one embodiment, the method also creates a repository for storing, e.g., in a cache, certain information that is frequently requested by the software applications.

In one embodiment, the software applications are categorized as “critical” or “non-critical” with respect to the requested information. For example, a location-based mobile photo-sharing application, e.g., Instagram®, may be categorized as a “critical” application with respect to needing location information. Similarly, a navigation application may also need location information continuously to provide the innate navigation function and, as such, would also be deemed to be a “critical” application with respect to needing location information. In other words, location information is a necessary component of the location-based mobile photo-sharing application and navigation application.

In another example, an online gaming application may be categorized as a “non-critical” application with respect to the same location information. For instance, the online gaming application may only need to know the location information for compliance with licensing agreements that are based on large geographical areas. For example, the licensing agreement may be based on whether the mobile device is in a particular continent, e.g., Europe, Asia, North America, etc. As such, the online gaming application may not need a continuous update with respect to real time location information.

In one embodiment, the present method enables applications that are categorized as “non-critical” to access requested information that is stored in cache. In contrast, the present method enables applications that are categorized as “critical” to access information that is determined in substantially real-time. In other words, information is not determined in substantially real-time for applications that are categorized as “non-critical.” For the present disclosure, information in the cache is defined as stored information.

In contrast, substantially real-time information is defined as information that is determined when a received request from an application is processed by the operating system of the mobile endpoint device. For example, the location information that is determined by the operating system receiving a request from an application is considered substantially real-time location information. However, if the location information is provided to the application by simply retrieving the location from the cache memory (i.e., the last updated version of the information in the cache memory), the location information is considered to be stored or cached location information and not substantially real-time location information. In other words, the act of determining the real-time location information occurs after the operating system receives the request from the application. The term “substantially real time” is intended to convey that there is a small amount of elapsed time (e.g., processing time) before the requested information can be determined by the operating system of the mobile endpoint device. As such, the terms “substantially real time” and “real time” are used interchangeably throughout the present disclosure and should not be interpreted that the requested information is instantaneously obtained. A certain amount of processing delay is anticipated based on the various physical factors or constraints of the mobile endpoint device.

In one embodiment, the information that is stored in the cache is updated periodically (e.g., based upon some predefined schedule, e.g., every 10 minutes, every hour, every day, every week, and so on). In one embodiment, information that is stored in the cache is updated upon responding to a request from a “critical” application that requested the information. For example, if a critical application requested location information, then the location information stored in the cache can be updated with the requested location information as well.

In one embodiment, the categorizing of the software applications as either a “non-critical” application or a “critical” application for a particular type of information is performed by a user of the mobile endpoint device or a network service provider of a wireless communication service, e.g., a cellular service. For example, a network service provider or the user may choose and configure each software application as either “critical” or “non-critical,” for location information. For example, social media users, posting pictures tagged with specific locations, may categorize these applications that require location information as “critical.” In contrast, the same users may categorize software applications that require location information for licensing purposes as “non-critical.” For example, the licensing requirement of these applications may only require that the applications verify whether the application is currently being used in a particular region of the world. Such verification may only be required when the application is loading. For such applications, the user's location information may need to be sufficiently accurate only to the extent of determining the country or continent that the user is currently located. Since most users generally would not be travelling between countries or continents within a short period of time, the location information stored in the cache should be sufficiently accurate to meet the requirements for such applications.

In one embodiment, the categorizing of the applications is performed via a payment model, wherein the payment model is based on a particular payment being associated with a particular type of access. In one example, the payment model may provide access to cache information without a fee, while the payment model may require a payment for receiving real-time information. In other words, an application may be categorized as “non-critical” when a payment has not been paid, whereas another application may be categorized as “critical” when a payment is paid.

For example, developers of applications that require real-time information may purchase an access key that enables their respective applications to bypass the cache information, and obtain real-time information instead. For instance, a location-based mobile photo-sharing application, e.g., Instagram, may need location data that is determined in near real-time. In one embodiment, the developer of the location-based mobile photo-sharing application may then pay the manufacturer of the mobile endpoint device to acquire the access key that will allow its location-based mobile photo-sharing application to request substantially real time location information from the operating system of the mobile endpoint device.

Applications with the access key (e.g., deemed to be “critical” applications) are then allowed to place extra load on the processor of the mobile endpoint device such that these applications are able to receive the substantially real-time information. Other applications without the access key are categorized as “non-critical.” These “non-critical” applications will retrieve data from the cache as opposed to receiving data in substantially real-time. Since these “non-critical” applications only access the cache memory, the overall consumption of battery and processing power of the mobile endpoint device are reduced.

In one embodiment, the access key may be provided based on a type of a device, a model no., etc. In other words, a blanket licensing agreement between the manufacturer of the mobile endpoint device and various application developers may be established. The mobile endpoint devices are then manufactured in accordance with the licensing agreement and distributed to users with the access key embedded within mobile endpoint devices. Approved application developers are then provided with the necessary information that will allow their applications to access the access key.

In one embodiment, each access key is linked to a particular type of data, e.g., location data. In other words, one access key is used to access a specific type of real-time data, e.g., location data, whereas another access key is used to access another type of real-time data, e.g., recent retail purchasing data of a user, current financial data of a user, and so on.

In one embodiment, the access key is provided by a network service provider that provides the wireless communication service. For example, Instagram® may pay a wireless communication service provider, e.g., a cellular service provider, such that pictures that are posted on Instagram may have location information that is determined in substantially real-time.

In one embodiment, a pay-as-you-use model may also be used. For example, it may be acceptable for a particular application to use data that is stored in the cache as long as the “freshness” of the stored data is within acceptable limit of the application, e.g., the stored data is not older than a pre-determined time period. However, if the stored data is too old, then the real-time determination of data is performed and the requesting application will be assessed a charge for receiving the substantially real time data. Thus, the application needs to pay for the real-time data only when the requested information has to be retrieved in real-time. The operating system of the mobile endpoint device then keeps track of the number of times that the application has requested real time information retrieval. In turn, the network service provider may receive from the mobile endpoint device a list of applications that have requested real time data retrieval and the accompanying number of times such retrievals have occurred. The application developers may then pay the network service provider based on the reported usage.

For example, location information for an application may be considered sufficiently fresh as long as the location information is less than two hours old. Then, if a user posts 100 pictures using an application with location information in a month and real-time location information was retrieved only once within the one month time period, then the developer of the application would pay for only one location information retrieval. In other words, the operating system of the mobile endpoint device would have responded to the other 99 requests with location information stored in the cache. Hence, for applications that are able to use older data that is stored in the cache, the pay-as-you-use model will be more economical.

In yet another embodiment, the access key is provided by the manufacturer of the operating system and not the manufacturer of the mobile endpoint device. For example, the developer of an application may pay the operating system manufacturer to gain access to the access key. When the operating system is downloaded on the mobile endpoint device, the corresponding operating system may embed the access key for the “paying” applications.

In one embodiment, the network service provider may limit certain applications from accessing real-time information based on user input. For example, a user may request certain applications that are known to be a drain on the performance and battery life of the mobile endpoint device to be limited to accessing data only from the cache. Limiting certain applications from accessing real-time information may improve the overall usability and performance of the mobile endpoint device.

In one embodiment, the information that can be requested may comprise one or more of: current location information of the mobile endpoint device, signal strength information perceived by the mobile endpoint device, signal over interference information perceived by the mobile endpoint device, signal over noise information perceived by the mobile endpoint device, recent retail purchasing information of a user (e.g., recent purchases), current financial information of a user (e.g., recent stock trades), and so on. It should be noted that this is not an exhaustive list and is provided only as an example.

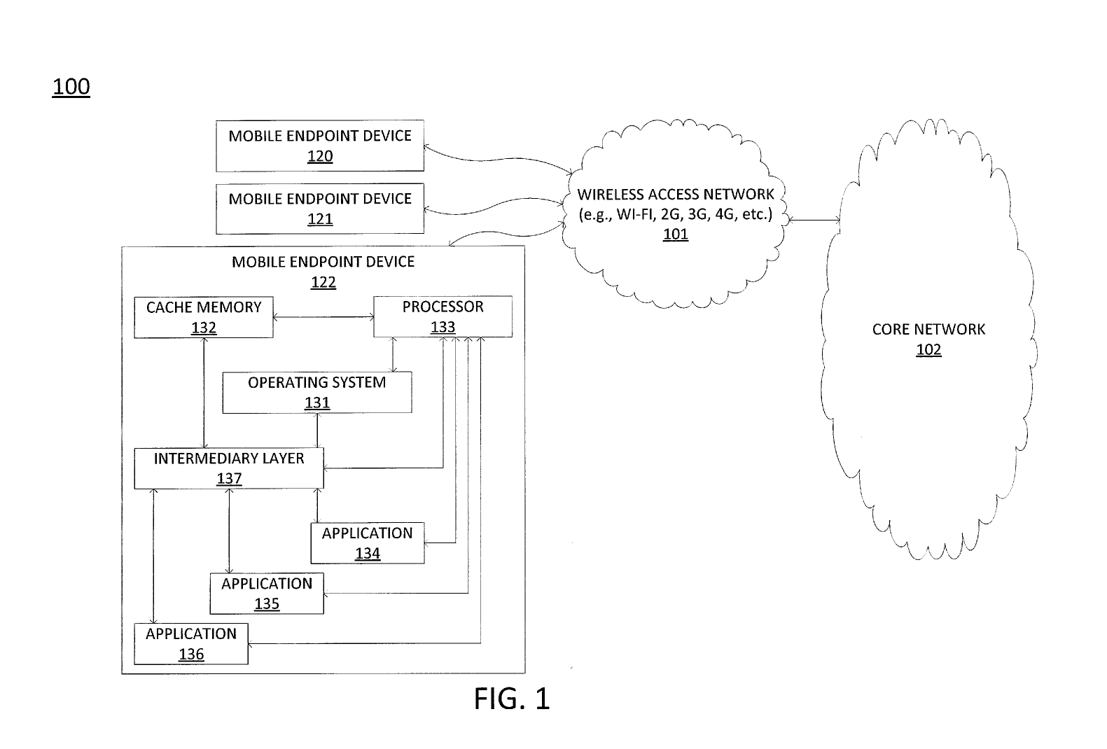

FIG. 1 illustrates an example network 100 related to the present disclosure. In one illustrative embodiment, the network 100 comprises a wireless network 101 and a core network 102. The wireless network 101 may comprise any number of wireless access networks, e.g., Wireless-Fidelity (Wi-Fi) networks, 2G networks, 3G networks, LTE networks, etc. The core network 102 may comprise an IP based core network having any number of application servers, gateway devices, routers, and switches operated by a network service provider. FIG. 1 also illustrates various user endpoint devices, e.g., mobile endpoint devices 120-122.

In one embodiment, each mobile endpoint device 120, 121 or 122 comprises: an operating system 131, a cache memory 132, a processor 133, software applications 134-136, and an intermediary layer 137 that operates between each application 134, 135 or 136 and the operating system 131. In one embodiment, the intermediary layer 137 can be an application, e.g., a middleware application. In one embodiment, each mobile endpoint device may comprise a mobile phone, a smart phone, a computing tablet, a smart watch, or a pair of eye wear or eye glasses.

It should be noted that the above example network 100 is only illustrative and that the number of access networks, the number of core networks, and the number of components within the mobile endpoint device, are not limited as shown. Any number of access or core networks or components within the mobile endpoint device can be deployed. For example, there may be any number of different types of wireless networks, core networks, mobile endpoint devices, components of the mobile endpoint device, etc.

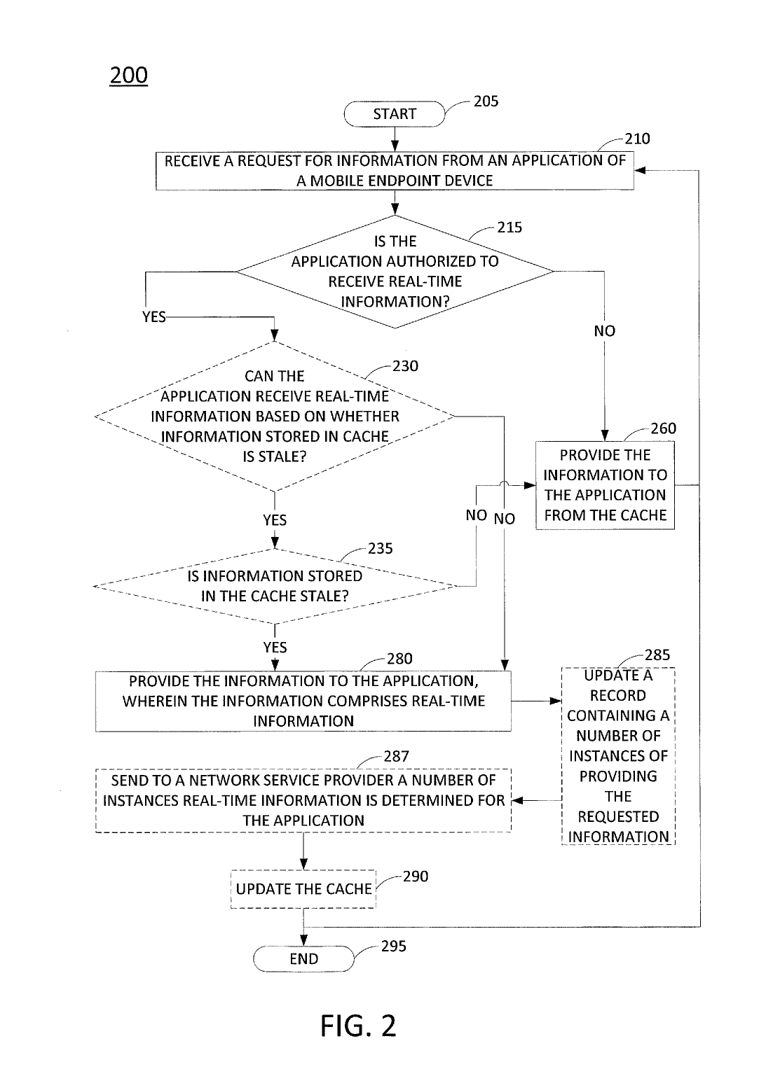

FIG. 2 illustrates a method 200 of the present disclosure for providing information to an application of a mobile endpoint device. For example, the method may be implemented in a mobile endpoint device accessing wireless services via a wireless network, e.g., an LTE network. For instance, the method may be implemented in an intermediary layer of a mobile endpoint device, wherein the intermediary layer is implemented between the operating system of the mobile endpoint device and various software applications. The intermediary layer is implemented for enabling the software applications to receive information via the operating system of the mobile endpoint device. Method 200 starts in step 205 and proceeds to step 210.

In step 210, method 200 receives a request for information from an application of a mobile endpoint device. For example, the intermediary layer of the mobile endpoint device may receive a request for information, e.g., location information, from an application deployed in the mobile endpoint device, e.g., a location-based mobile photo-sharing application.

In step 215, method 200 determines if the application is authorized to receive real-time information, e.g., whether the application is deemed to be a critical application or a non-critical application. If the application is authorized to receive real-time information (e.g., a critical application), the method proceeds to step 230. Otherwise (e.g., a non-critical application), the method proceeds to step 260.

For example, the need to provide real-time information may be based on a determination of whether or not the application is categorized as “critical.” If the application is not categorized as “critical,” the method may not be authorized to receive real-time information and the method proceeds to step 260. If the method is categorized as “critical,” the application is authorized to receive real-time information and the method proceeds to step 230.

In optional step 230, method 200 determines whether the application is capable of receiving real-time information based on whether the requested information that is stored in cache is stale. In other words, some applications may have the capability where the applications can tolerate a certain amount of staleness of the requested information such that stored information in the cache may be sufficient to meet the application's requirement. For example, location information of the mobile endpoint device that was obtained ten (10) minutes ago may still be sufficiently recent to satisfy the requirement of a location based photo sharing application. In contrast, a navigation application will constantly need real time location information such that location information that is ten minutes old cannot be used.

In step 230, if the application is capable of receiving real-time information based on whether the requested information that is stored in cache is stale, the method proceeds to step 235. Otherwise, the method proceeds to step 280.

In optional step 235, method 200 determines whether the information stored in the cache is stale. If the information stored in the cache is stale, then the method proceeds to step 280. Otherwise, the method proceeds to step 260.

In step 260, method 200 provides the information to the application from the cache. For example, the method provides a response to the request by retrieving the requested information from the cache memory. The method then proceeds either to step 210 or to step 295 to end processing the present request.

In step 280, method 200 provides the requested information to the application, wherein the information comprises substantially real-time information. For example, the method obtains the requested information in real-time and provides the requested information to the application. For example, if the requested information is location information, then the method will determine the current location of the mobile endpoint device and provides the current location to the application. The real-time information is determined upon receiving the request from the application. In contrast, the cached information that is provided in step 260 contains information that was previously determined and stored in the cache memory prior to receiving the current request from the application.

In optional step 285, method 200 updates a record containing a number of instances of providing the requested information, e.g., providing real-time information to the application. For example, the method may be tracking the number of times that the requested information is provided to the application in real-time in response to a request from the application. For example, if the location of the mobile endpoint device was determined in real-time responding to a request received from a particular application, then the number of times that the location was previously determined on behalf of that particular application will be incremented, e.g., via a counter.

In optional step 287, method 200 sends to a network service provider the record of the number of instances real-time information is determined for the application. For instance, a network service provider may have implemented the current method as a pay-as-you-use model for real-time information. The method in the mobile endpoint device may then track instances of determination of real-time information for each application. The method may then send accounting information to the network service provider in accordance with a pre-determined time interval, e.g., daily, weekly and the like. The record of the number of instances (i.e., accounting information) that is received may then be used by the network service provider to obtain payment from the developer of the application.

In optional step 290, method 200 updates the cache. For example, method 200 may update the cache memory based on the latest real-time information that is determined. The method then proceeds either to step 210 or to step 295 to end processing the present request.

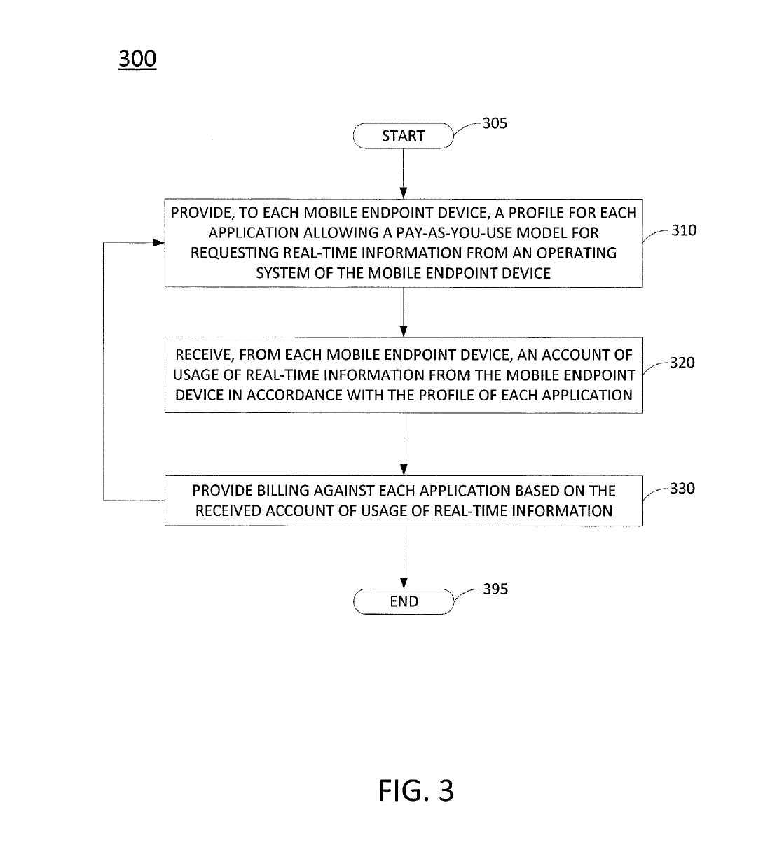

FIG. 3 illustrates a method 300 of the present disclosure for providing a billing for an application of a mobile endpoint device. In one embodiment, method 300 may be implemented in an application server of a network service provider. Method 300 starts in step 305 and proceeds to step 310.

In step 310, method 300 provides, to each mobile endpoint device, a profile for each application allowing a pay-as-you-use model for requesting real-time information from an operating system of the mobile endpoint device. For example, the method provides to the mobile endpoint devices a list of applications for which a number of instances that real-time information is to be tracked and reported.

In step 320, method 300 receives, from each mobile endpoint device, an account of usage of real-time information from the mobile endpoint device in accordance with the profile of each application. For example, the method receives from each mobile endpoint device, records as to how many times real-time location information is determined for each application. Similarly, for each type of information, the account of usage of real-time information is received.

In step 330, method 300 provides billing against each application based on the received account of usage of real-time information. For example, if the billing is for a location based photo sharing application and the real-time information is location information, then the method provides a billing to the developer of the location based photo sharing application based on the number of times location information is obtained in real-time for the location based photo sharing application. The method then proceeds either to step 310 or to step 395 to end the current process.

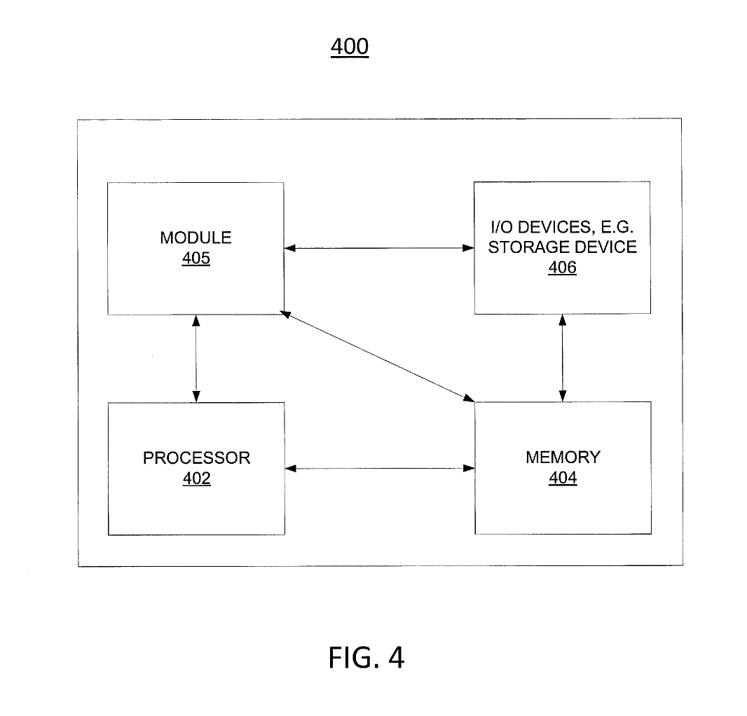

FIG. 4 depicts a high-level block diagram of a computer suitable for use in performing the functions described herein. As depicted in FIG. 4, the system 400 comprises one or more hardware processor elements 402 (e.g., a central processing unit (CPU), a microprocessor, or a multi-core processor), a memory 404, e.g., random access memory (RAM) and/or read only memory (ROM), a module 405 for providing information to an application, and various input/output devices 406 (e.g., storage devices, including but not limited to, a tape drive, a floppy drive, a hard disk drive or a compact disk drive, a receiver, a transmitter, a speaker, a display, a speech synthesizer, an output port, an input port and a user input device (such as a keyboard, a keypad, a mouse, a microphone and the like)). Although only one processor element is shown, it should be noted that the computer may employ a plurality of processor elements. Furthermore, although only one computer is shown in the figure, if the method 200 or method 300 as discussed above is implemented in a distributed or parallel manner for a particular illustrative example, i.e., the steps of the above methods 200 and 300, or the entire method 200 or method 300 are implemented across multiple or parallel computers, then the computer of this figure is intended to represent each of those multiple computers.

Furthermore, one or more hardware processors can be utilized in supporting a virtualized or shared computing environment. The virtualized computing environment may support one or more virtual machines representing computers, servers, or other computing devices. In such virtualized virtual machines, hardware components such as hardware processors and computer-readable storage devices may be virtualized or logically represented.

It should be noted that the present disclosure can be implemented in software and/or in a combination of software and hardware, e.g., using application specific integrated circuits (ASIC), a programmable gate array (PGA) including a Field PGA, or a state machine deployed on a hardware device, a computer or any other hardware equivalents, e.g., computer readable instructions pertaining to the method(s) discussed above can be used to configure a hardware processor to perform the steps, functions and/or operations of the above disclosed methods. In one embodiment, instructions and data for the present module or process 405 for providing information to an application (e.g., a software program comprising computer-executable instructions) can be loaded into memory 404 and executed by hardware processor element 402 to implement the steps, functions or operations as discussed above in connection with the exemplary method 200 or method 300. Furthermore, when a hardware processor executes instructions to perform “operations”, this could include the hardware processor performing the operations directly and/or facilitating, directing, or cooperating with another hardware device or component (e.g., a co-processor and the like) to perform the operations.

The processor executing the computer readable or software instructions relating to the above described method(s) can be perceived as a programmed processor or a specialized processor. As such, the present module 405 for providing information to an application (including associated data structures) of the present disclosure can be stored on a tangible or physical (broadly non-transitory) computer-readable storage device or medium, e.g., volatile memory, non-volatile memory, ROM memory, RAM memory, magnetic or optical drive, device or diskette and the like. Furthermore, a “tangible” computer-readable storage device or medium comprises a physical device, a hardware device, or a device that is discernible by the touch. More specifically, the computer-readable storage device may comprise any physical devices that provide the ability to store information such as data and/or instructions to be accessed by a processor or a computing device such as a computer or an application server.

While various embodiments have been described above, it should be understood that they have been presented by way of example only, and not a limitation. Thus, the breadth and scope of a preferred embodiment should not be limited by any of the above-described exemplary embodiments, but should be defined only in accordance with the following claims and their equivalents.

What is claimed is:

1. A method for providing information to an application of a mobile endpoint device, comprising:
receiving, via a processor, a request for the information from the application of the mobile endpoint device; and
providing, via the processor, the information to the application from a cache when the application is deemed to be a non-critical application.

2. The method of claim 1, further comprising:
providing the information to the application in substantially real time when the application is deemed to be a critical application and the application is not capable of receiving the information based on whether information stored in the cache is stale.

3. The method of claim 1, further comprising:
determining whether the information stored in cache is stale, when the application is capable of receiving the information based on whether information stored in the cache is stale.

4. The method of claim 3, further comprising:
providing the information to the application from the cache when the information stored in cache is not stale.

5. The method of claim 3, further comprising:
providing the information to the application substantially in real time, when the information stored in cache is determined to be stale.

6. The method of claim 5, further comprising:
updating the cache in accordance with the information that is provided to the application.

7. The method of claim 5, further comprising:
sending to a network service provider a record of a number of instances that the information is determined substantially in real time for the application.

8. The method of claim 7, wherein the sending is performed in accordance with a pre-determined interval.

9. The method of claim 1, wherein the information that is stored in the cache is updated periodically.

10. The method of claim 2, wherein whether the application is deemed to be a critical application or a non-critical application is based on an input provided by a user of the mobile endpoint device.

11. The method of claim 2, wherein whether the application is deemed to be a critical application or a non-critical application is performed by a network service provider providing a mobile communication service to the mobile endpoint device.

12. The method of claim 1, wherein an access key is provided to the application when the application is deemed to be a critical application.

13. The method of claim 12, wherein the access key is provided by a network service provider that provides a mobile communication service to the mobile endpoint device.

14. The method of claim 12, wherein the access key is provided by a manufacturer of an operating system of the mobile endpoint device.

15. The method of claim 12, wherein the access key is provided based on a licensing agreement between a manufacturer of the mobile endpoint device and a developer of the application.

16. The method of claim 12, wherein the access key is based on a type of the mobile endpoint device.

17. The method of claim 12, wherein the access key is based on a model number of the mobile endpoint device.

18. The method of claim 1, wherein the information that is requested comprises at least one of: location information, signal strength information, signal over interference information, signal over noise information, purchasing information, or financial information.

19. A tangible computer-readable storage device storing a plurality of instructions which, when executed by a processor, cause the processor to perform operations for providing information to an application of a mobile endpoint device, the operations comprising:
receiving a request for the information from the application of the mobile endpoint device; and
providing the information to the application from a cache when the application is deemed to be a non-critical application.

20. An apparatus for providing information to an application of a mobile endpoint device, comprising:
a processor; and
a computer-readable storage device storing a plurality of instructions which, when executed by the processor, cause the processor to perform operations, the operations comprising:
receiving a request for the information from the application of the mobile endpoint device; and
providing the information to the application from a cache when the application is deemed to be a non-critical application.
